(19) United States
(12) Patent Application Publication
(10) Pub. No.: US 2026/0086830 A1
(43) Pub. Date: Mar. 26, 2026

(54) SERVER APPARATUS FOR PROVISION OF AT LEAST ONE GRAPHICAL USER INTERFACE TO A CLIENT APPARATUS, CLIENT APPARATUS, SYSTEM, METHOD, COMPUTER PROGRAM, AND ELECTRONICALLY-READABLE DATA MEDIUM

(71) Applicant: Siemens Healthineers AG, Forchheim (DE)

(72) Inventor: Hans Schweizer, Plattling (DE)

(21) Appl. No.: 19/333,737

(22) Filed: Sep. 19, 2025

(30) Foreign Application Priority Data
Sep. 26, 2024 (DE) 10 2024 209 288.6

(51) Int. Cl. G06F 9/451; G06F 3/14; H04L 65/60

(52) U.S. Cl. CPC G06F 9/451; G06F 3/14; H04L 65/60

(57) ABSTRACT

A server apparatus for provision of at least one graphical user interface to a client apparatus over a packet-based network is disclosed. The server apparatus includes a display adapter apparatus configured, in accordance with a display entity configuration, to operate a virtual display entity in which a virtual display facility is provided. The server apparatus further includes an application module configured to generate character data for definition of the graphical user interface of an application of the application module and to provide the character data to the display adapter apparatus for the virtual display entity.

The display adapter apparatus is configured to generate display data using the character data for display of the graphical user interface in the virtual display facility of the virtual display entity to a graphics card of the server apparatus and to transfer the generated display data to a streaming server facility of the server apparatus.

The present patent document claims the benefit of German Patent Application No. 10 2024 209 288.6, filed Sep. 26, 2024, which is hereby incorporated by reference in its entirety.

### TECHNICAL FIELD

The present disclosure relates to a server apparatus for provision of at least one graphical user interface to a client apparatus over a packet-based network, to a client apparatus for receiving at least one graphical user interface from a server apparatus over a packet-based network, to a system having at least one server apparatus and at least one client apparatus, to a method for operating a system, to a computer program, and to an electronically-readable data medium.

### BACKGROUND

Modern medical devices, for example, mobile C-arm devices, have a plurality of internal functions for further processing of two-dimensional (2D) and three-dimensional (3D) image data with internal functions of the built-in imaging systems. Despite this, there is an increasing need for expanding this basic functionality by third-party provider applications, in order for example to keep internal development efforts for niche applications small or to integrate specific functionalities, in which a third-party provider has specialized, into the devices. Third-party providers primarily involve third-party providers of medical applications.

On the one hand, this may be realized with the so-called syngo. via OpenApps concept from Siemens Healthineers. Here, third-party provider applications may be executed on a separately provided server apparatus, the AppHost Computer, in a functionally isolated environment within the medical device, in order to prevent any mutual unintended influencing of medical device and third-party provider application. This server apparatus is located within the Siemens Healthineers system, i.e., with this type of integration, only the software of the third-party provider is executed on a server apparatus provided. This separation is needed for safety reasons so that, with malfunctions of the externally developed applications, no negative influencing of the actual medical products of the system may arise.

On the other hand, this may be realized with a network graphical user interface streaming interface, with the aid of which interactive screen contents from third-party provider systems, (e.g., medical navigation systems), may be streamed from outside the system by Ethernet-based streaming into the system. This concept is similar to Remote Desktop applications, for example, but has additional functions to provide the functional safety during transmission and display of the third-party provider screen contents by latency monitoring, for example. The functional safety is relevant for many medical applications, such as for medical navigation systems and/or operation systems. Here, the latency times may not exceed specific limit values. Acceptable solutions for the functional safety demanded are not adequately provided by current remote desktop applications.

To meet the challenges, approaches exist in the current prior art such as the use of video distribution solutions in which monitor signals are tapped off from medical devices with dedicated HW outputs and output on other display devices. These solutions have the advantage that, without intervention into the SW of the third party provider system, they make a display of the GUI possible and, through the use of standard interfaces such as HDMI or DisplayPort, achieve a low latency. The disadvantage is the complex additional cabling and the lack of a back channel for transfer of user interactions with the displayed GUI for remote control purposes. In order to achieve this functionality too, further additional cables, (e.g., USB cables), and additional hardware, (e.g., KVM switches), are necessary. Moreover, not all external third-party provider systems have the necessary video outputs for providing GUI pixel data on the way to a classical video distribution.

A further approach is the use of “Remote Desktop” or “Terminal Server” solutions in which the (remote operation) of GUIs on a server by a client is made possible. Here, the data of both the GUI and also of operator interactions is transferred over a packet-based medium such as Ethernet. The advantage of this solution is simple cabling, since only one network cable is necessary.

The disadvantage of the known approaches is that, when video distribution solutions are used, as a rule a smaller bandwidth of the medium used is available and when standard protocols are used, no functionally safe monitoring specifically of the safety-critical latency of the displayed graphical user interface of the server apparatus to be operated is possible. Although there are field bus systems such as ProfiNet or EtherCAT that provide a guaranteed response time, these solutions are cost-intensive and for many third-party provider systems, unlike Ethernet, are not available beforehand. This drives up effort and costs of linking in such systems. The desire is thus to provide a solution that does not require any provision of additional components.

Corresponding remote desktop solutions may be used without provision of additional hardware. For use of the suitable remote desktop solutions, such as network graphical user interface streaming, the third-party provider of the interactive application integrates a reference code of the video server software solution provided in a complicated and error-prone manner into the software of their application. Through the reference code provided, an interface for provision of a stream to a client apparatus may be provided in the application. This is followed by complex verification and validation acts until the application and the client apparatus provided by the third-party provider may be enabled in a combination declaration. In this method, the third-party provider cannot have any influence on the latency time threshold values by which the client apparatus informs the user when the threshold is exceeded. The value is instead set to a fixed value by the client apparatus.

Additionally, with this method, the interface is revealed because source code is provided. Moreover, for changes to the protocol, the software of the application of the third-party provider additionally has to be configured and enabled once again in an expensive manner.

The following challenges to be met arise from the prior art.

The high-resolution user interface of third-party provider applications is to be displayed with low latency and high image quality, (e.g., visually lossless or physically lossless), on the display faculty of the actual medical device. The resolution of the display on the OpenApps PC is configured dynamically to the respective current display range of the third-party provider application of the image system screen and in the system context. The third-party provider application may be capable of transmitting image contents to secondary operating units (TouchUIs) of the medical device in order to make operation outside of the sterile environment of the medical device possible. Third-party providers of safety-critical applications is given the option of predetermining a maximum permitted latency for the stream and of being notified if this latency is exceeded, in order to be able to carry out corresponding measures. The integration of inventory applications from third-party providers into the system is possible in a simple manner and with little effort.

### SUMMARY AND DESCRIPTION

The objective of the present disclosure is therefore to specify a solution that makes it possible to transmit a graphical user interface of a server apparatus to a display facility of a client apparatus in which the necessity of adapting the application that provides the graphical user interface is kept to the minimum. In this case, the solution may provide that the integration of the application on the third-party provider side may be carried out easily and efficiently, while an optimum performance and safety is provided for the interaction of the application with the server apparatus.

The scope of the present disclosure is defined solely by the appended claims and is not affected to any degree by the statements within this summary. The present embodiments may obviate one or more of the drawbacks or limitations in the related art.

A first aspect of the disclosure relates to a server apparatus for provision of at least one graphical user interface to a client apparatus over a packet-based network. The at least one graphical user interface in this case may be an interactive graphical user interface. The server apparatus includes a display adapter apparatus configured to operate a virtual display entity in accordance with a display entity configuration in which a virtual display facility is provided. The server apparatus contains an application module configured to generate character data for definition of the graphical user interface of an application of the application module and to provide this data to the display adapter apparatus for the virtual display entity. The display adapter apparatus is configured to use the character data for generation of display data, which may then be displayed in the virtual display facility of the virtual display entity on a graphics card of the server apparatus. Subsequently, the display adapter apparatus transfers the generated display data to a streaming server facility of the server apparatus, which forwards this data in a display data stream via an assigned streaming entity to a streaming proxy facility of the client apparatus. The streaming proxy facility is configured to forward the display data stream received via the assigned streaming entity to a display module of the client apparatus, which is configured to send the display data to the display facility of the client apparatus.

The client apparatus may involve an apparatus for controlling an imaging apparatus. The imaging apparatus may be a computed tomography apparatus or a nuclear spin tomography apparatus. It may involve a mobile C-arm, which may be provided for intraoperative use. It may be necessary here to integrate applications for control of apparatuses for carrying out an operation. These may be third-party provider applications for real time navigation based on 2D/3D x-ray images. A high degree of functional safety in the presentation of a graphical user interface is required here. The client apparatus has the display facility on which information or a graphical user interface for controlling the client apparatus and/or the imaging apparatus as well as diagnostic images, which may be generated by the imaging apparatus, may be provided. The client apparatus may have an input apparatus, which may be configured to capture user inputs.

The server apparatus is an apparatus that differs from the client apparatus and may provide an additional application that may be connected with the imaging apparatus. The server apparatus may be intended for control of an operation instrument. It may be necessary or advantageous to display a graphical user interface for controlling the server apparatus and/or for displaying contents, which are provided by the server apparatus, on the display facility of the client apparatus. The server apparatus and the client apparatus may be connected to one another over a packet-based network for exchange of data.

So that the graphical user interface of the server apparatus may be provided to the client apparatus, the server apparatus includes a display adapter apparatus. The display adapter apparatus is configured to operate at least one virtual display entity. A virtual display facility is provided in the at least one virtual display entity. The virtual display facility may simulate a physical display facility, for example a monitor.

The application module of the server apparatus is configured to generate character data for definition of the graphical user interface and to provide the data to the virtual display entity of the display adapter apparatus. The character data is data that describes the graphical user interface to be output. The character data is intended to instruct a graphics card to create display data, which may be displayed by a display facility.

The display adapter apparatus is configured to transfer the character data to the graphics card of the server apparatus, in order, based on the character data, to generate the display data for the display of the graphical user interface in the virtual display facility of the virtual display entity. In other words, the character data is provided to the graphics card together with information about the virtual display facility. The information may include an image refresh rate, a color depth, and/or a resolution of the virtual display facility. The graphics card is configured to generate the display data based on the character data in accordance with the information and to provide the same to the display adapter apparatus.

The display adapter apparatus is configured to provide the display data to a streaming server facility of the server apparatus. The streaming server facility is configured, in a streaming entity assigned to the virtual display facility, to communicate with a streaming proxy facility of the client apparatus over the packet-based network. The streaming server facility is configured to forward the display data in a display data stream of the streaming entity over the packet-based network to the streaming proxy facility of the client apparatus. The streaming entity may be provided via a network graphical user interface streaming interface.

The disclosure makes it possible to display the graphical user interface of the server apparatus over the packet-based network on the display facility of the client apparatus. The advantage of the disclosure includes the provision of the display adapter apparatus. This makes it possible to accept the character data of the application module and adapt the display data through the provision of the virtual display facility, independent of a physically present display facility available on the third-party provider system. Advantageously, the graphics card of the server apparatus, e.g., a hardware functionality of the physically present graphics card such as a 3D or AI accelerator of the server apparatus, is used for provision of the display data and is diverted to the virtual display facility. This means that the physically present graphics card renders hardware-accelerated contents of the virtual display facility. The transmission of the display data is undertaken by the server apparatus. It is thus not necessary to adapt the application module for provision of the display data stream.

In certain embodiments, the streaming server facility is configured, in the streaming entity, to receive user inputs from the streaming proxy facility of the client apparatus and to provide them to the display adapter apparatus for the virtual display entity, which is allocated to the streaming entity. The display adapter apparatus is configured to forward the user inputs to the application module of the display entity.

In other words, there is provision for the display module of the client apparatus to be configured to receive user inputs of an input facility. In other words, there is provision in the development for the system not only to be configured for display of the graphical user interface of the application module generated by the server apparatus by the client apparatus, but also for transmitting user inputs for controlling the application module from the client apparatus to the server apparatus. For this reason, the display module is configured to receive the user inputs, which are provided by an input facility.

The input facility may be a mouse, a keyboard, and/or a touch-sensitive layer of the display facility, by which the graphical user interface is displayed. The display module is configured to provide the user inputs to the streaming proxy facility. The streaming proxy facility of the client apparatus is configured to transfer the user inputs in a user input stream over the packet-based network to the streaming server facility of the server apparatus. The streaming proxy facility may assign the user inputs to the streaming entity, which is assigned to the display entity concerned.

The streaming server facility may unpack the user input stream of the streaming entity and extract the user inputs. The streaming server facility provides the user inputs to the display adapter apparatus, which in turn forwards the user inputs to the virtual display entity of the display adapter apparatus, which is assigned to the streaming entity.

The display adapter apparatus is configured to provide the user inputs to the application module that is assigned to the display entity. The application module is configured to process the received user inputs, as a result of which the user inputs executed may be implemented. This development makes it possible to incorporate the transmission of user inputs to the application module.

In certain embodiments, the streaming configuration describes latency threshold values for the streaming entity. The latency threshold values relate to the display data stream and/or to the input data stream of the streaming entity. The latency threshold values are assigned predetermined measures, which are to be introduced by the streaming server facility as soon as the latency threshold value concerned is exceeded by the latency value of the streaming entity. There may be provision that, for an exceeding of one of the latency threshold values by the latency value, a signal is sent to the application module by the streaming server facility, which initiates a predetermined measure in the application module and/or informs the application module about the exceeding of the latency threshold value. The application module in this case may provide a warning in the graphical user interface or initiate an output of an acoustic alarm message. There may also be provision for specific functions provided by the application module as measures to be able to be deactivated. There may be provision for an application module for operation of a navigation device of an operation instrument to deactivate the activation of the operation instrument via the client apparatus when the assumption is that, owing to the latency threshold being exceeded, reliable operation is not guaranteed. The development produces the advantage that taking account of the latency value and initiation of latency value-dependent measures is made possible.

In certain embodiments, the streaming server facility is configured to configure input drivers and display drivers of the virtual display facility of the virtual display entity.

In certain embodiments, the display adapter apparatus is configured, in a multi entity mode, to operate a number of the virtual display entities in accordance with respective display entity configurations. This means that the display adapter apparatus is configured to provide a number of the virtual display entities at the same time, wherein each display entity of the virtual display entities is defined by a separate display entity configuration. The display adapter apparatus is also configured to provide the respective display data for display of the respective graphical user interface in the respective virtual display facility of the respective virtual display entity to the graphics card of the server apparatus. This means that the display adapter apparatus for each virtual display entity deals with the generation of the necessary display data by the graphics card and sends this to the respective virtual display facility in order to display the graphical user interface of the corresponding entity.

Furthermore, the display adapter apparatus is configured to transfer the display data of the respective virtual display entity to the streaming server facility of the server apparatus. The streaming server facility is configured, in the streaming entity assigned to the respective virtual display facility, to transfer the respective display data in the display data stream over the packet-based network to the streaming proxy facility of the client apparatus, which is assigned to the virtual display entity concerned. This means that the streaming server facility receives the display data of the virtual display entities from the display adapter apparatus and sends this via the assigned streaming entities to the streaming proxy facility of the respective client apparatus. There may be provision for using a number of the virtual display entities of virtual display facilities at the same time. In this case, individual of the virtual display entities may be used for provision of the display data for a number of streams. In this case, an individual combination of a streaming configuration and a display entity configuration may be provided for each combination of a stream and a virtual display facility. For each of the combinations, this enables an individual set of configuration values, such as for example latency threshold values, to be set. This means, in accordance with the streaming configuration, that a warning may be output to one of the combinations for example as from a latency >100 ms, while in accordance with the streaming configuration a warning may be output to a further of the combinations, for example, as from a latency >1000 ms. The first combination may be required for a display in real time, while the second combination may relate to a display in non-real time. The development produces the advantage that a number of the virtual display entities may be provided in parallel.

In certain embodiments, the display adapter apparatus is configured to receive the character data of the application module for definition of the graphical user interface and to provide a number of the virtual display entities to the display adapter apparatuses. This means that the display adapter apparatus is configured so that the display adapter apparatus receives the character data from the application module and makes this data available for a number of virtual display entities. The display facility of the virtual display entity is configured to display the character data provided and thus to show a graphical user interface for the user. By the display adapter apparatus providing this data to a number of virtual display entities, the display adapter apparatus may provide that each entity has the necessary information in order to provide a correct display to the user interface. The use of virtual display entities makes it possible to host and display a number of graphical user interfaces on a single server apparatus. The provision of the character data for a number of entities enables the display adapter apparatus to offer a scalable and flexible solution, which is able to be configured to different requirements and configurations.

Overall, this development of the disclosure allows an efficient use of the character data of the application module and a consistent presentation of the graphical user interface across a number of virtual display entities. The display adapter apparatus is thus capable of providing an adaptable and scalable solution for the display of graphical user interfaces.

In certain embodiments, the display adapter apparatus is configured to receive a number of the character data of respective application modules for definition of the respective graphical user interface and to provide these to the respective virtual display entities of the display adapter apparatus. This means that the display adapter apparatus is configured so that it receives character data from a number of application modules and forwards this data to the virtual display entity responsible in each case. Each application module provides a separate graphical user interface, which is defined by the corresponding character data. For this, the display adapter apparatus is capable of supporting a number of these application modules and forwarding the respective character data responsible to the correct virtual display entity. Through the use of virtual display entities, the display adapter apparatus may host and display a plurality of graphical user interfaces at the same time, wherein each entity represents a separate application with its own user interface. The provision of the character data for the respective virtual display entities makes possible a flexible and scalable solution, which is able to be configured to the various demands and configurations. Overall, this development of the disclosure makes possible an efficient use of the character data of a number of application modules and a correct presentation of the respective graphical user interfaces for the virtual display entities responsible.

In certain embodiments, the server apparatus includes a scaling facility. The scaling facility is configured to receive the display data of one of the virtual display entities for presentation of the graphical user interface concerned in accordance with the display entity configuration. The scaling facility is configured to generate scaled display data for presentation of at least one part of the graphical user interface in accordance with a scaling configuration based on the received display data. The scaling facility is configured to provide the scaled display data to the streaming server facility.

There may be provision for the display data to be scaled in such a way that the graphical user interface is scaled up or down. There may also be a cropping of part areas of the graphical user interface. This scaling is undertaken before the transfer of the scaled display data to the client apparatus. There may be provision for a virtual display facility with a resolution of 1920×1080 pixels to be operated in clone mode in addition to a real display facility of the server apparatus with a resolution of 1280×720 pixels. The scaling facility then scales a resolution of the display data down from 1920×1080 pixels to 1280×720 pixels. It may also crop the graphical user interface as a part image to a size of for example: 720×720 pixels. The server apparatus may be configured only to provide the display data that is required at run time. The advantage of the development lies in no additional rendering of the scaled display data being required. There is merely a scaling and/or cropping of existing display data, through which resources of the server apparatus may be saved.

In certain embodiments, the streaming server facility is configured to receive the display data from virtual display entities and to transfer this display data in a number of streaming entities in a packet-based network to the respective client apparatuses. The streaming server facility is configured so that the streaming server facility receives the display data of the virtual display entity and processes this data in a number of streaming entities. Each streaming entity is assigned in this case to a specific virtual display entity and transmits the display data of the respective display entity to the client apparatus. The data is transmitted over a packet-based network in which the data is sent in small packets. For this, the streaming server facility is capable of integrating the display data into the respective display data stream and of transferring it to the correct streaming proxy facility of the client apparatus. The use of a number of streaming entities enables the streaming server facility to process a plurality of display data at the same time and send the display data to the client apparatuses responsible, whereby an efficient and high-performance solution for the transmission of display data is provided. Overall, this development of the disclosure makes possible a reliable and fast transmission of display data over a packet-based network to the respective client apparatuses.

In certain embodiments, the display adapter apparatus is configured to receive a number of user inputs from various display modules and to forward these in accordance with a prioritization specification to the application module responsible. The display adapter apparatus is capable of receiving a number of user inputs from various display modules and processing this data. Each display module provides its own graphical user interface, which is controlled by user inputs. For this, the display adapter apparatus is capable of receiving these inputs and determining, with the aid of a prioritization specification, which inputs are to be forwarded to which application module. The use of a prioritization specification enables the display adapter apparatus to provide that the right user inputs are forwarded to the application module responsible and a correct function of the graphical user interface is guaranteed.

The advantages and developments set out above in conjunction with the server apparatus in accordance with the first aspect also apply by analogy to the client apparatus, the system, the method, the computer program, and the electronically-readable data medium. Accordingly, the features of the server apparatus shown are to be seen as features of the client apparatus, the system, the method, the computer program, and the electronically-readable data medium.

A second aspect of the disclosure relates to a client apparatus of a system for transmission of at least one graphical user interface of a server apparatus to a display facility of a client apparatus over a packet-based network. The client apparatus includes a streaming proxy facility, which is configured to receive display data in a display data stream via a streaming entity and to forward it to a display module of the client apparatus, which in its turn is assigned to a display facility. The streaming proxy facility is configured to forward the display data stream received via the streaming entity to the display module of the client apparatus. The display module is then configured to send this display data to the display facility and thus make it visible for the user.

The streaming proxy facility of the client apparatus is configured to receive the display data stream. The streaming proxy facility is configured to forward the display data of the display data stream to a display module, which is assigned to the display facility of the client apparatus on which the graphical user interface is to be displayed. The display module is configured to transfer the display data to the display facility concerned for presentation of the graphical user interface.

The display module may be configured to forward the display data to the display facility of the client apparatus in such a way that the graphical user interface generated by the server apparatus is provided in a predetermined display area of a graphical user interface provided by the client apparatus, or that an entire area of the display facility shows the graphical user interface generated by the server apparatus.

In certain embodiments, the client apparatus includes a control module. The control module is configured to create the display entity configuration through which the display entity is configured. In other words, it is necessary, for provision of the graphical user interface in the form intended, to provide the display entity configuration to the display adapter apparatus so that the display adapter apparatus provides the display entity accordingly. The graphics card is configured to generate the display data for presentation of the graphical user interface defined in the character data corresponding to the display entity configuration, which is created by the control module. The control module may be intended to change a screen resolution of the virtual display facility predetermined in the display entity configuration when, for example, the display area in which the graphical user interface is displayed on the client apparatus is changed. The control module may be provided on a computing facility that differs from the client apparatus and the server apparatus but also on the client apparatus and/or the server apparatus. Through the development, the advantage is produced of a dynamic and automatic adaptation of the display entity configuration being made possible.

In certain embodiments, the control module is configured to provide, to the streaming server facility via the streaming entity, a streaming configuration of the streaming entity. In other words, parameters of the streaming entity are determined by the streaming configuration. The streaming configuration may include various parameters and settings, such as the codec settings, bit rate, resolution, and other parameters that influence the quality and performance of the streaming. The streaming configuration may also predetermine individually configurable latency threshold values. The control module is configured to generate this streaming configuration and to send it to the streaming server facility, so that the streaming entity may be provided and/or configured accordingly by the streaming server facility. The control module may react automatically and dynamically to changes and provide that the streaming entity is correctly configured in accordance with current requirements.

The advantages and developments set out above in conjunction with the client apparatus in accordance with the second aspect also apply by analogy to the server apparatus, the system, the method, the computer program, and the electronically-readable data medium. Accordingly, the features presented of the client apparatus are to be seen as features of the server apparatus, the system, the method, the computer program, and the electronically-readable data medium.

A third aspect of the disclosure relates to a system, which includes at least one server apparatus in accordance with the first aspect and at least one client apparatus in accordance with the second aspect.

A fourth aspect of the disclosure relates to a method for operating a system for transmission of at least one graphical user interface of a server apparatus to a display facility of a client apparatus over a packet-based network. The method includes providing a virtual display entity by a display adapter apparatus of the server apparatus, in which a virtual display facility is provided, and sending of character data to the display adapter apparatus for the virtual display entity in order to define the graphical user interface of an application of the application module. The character data is then sent to a graphics card of the server apparatus and used by the streaming server facility in order to generate display data for the presentation of the graphical user interface. The streaming server facility provides a streaming entity assigned to the virtual display facility over the packet-based network and transfers the generated display data as a display data stream to the streaming proxy facility of the client apparatus. The streaming proxy facility receives the display data stream transferred via the assigned streaming entity and forwards it to a display module of the client apparatus, which is assigned to the display facility. The display module then sends the display data to the display facility.

For application cases or application situations that may be produced in the method and which are not explicitly described here, there may be provision, in accordance with the method, for an error message and/or a request for input of a user acknowledgement to be output and/or for a default setting and/or a predetermined initial state to be set.

The object stated above is also achieved by a computer program, which is able to be loaded directly into a memory of a computing facility. The computer program includes program means for carrying out the acts of the server apparatus and/or of the client apparatus of the method in accordance with the third aspect when the program is executed in the computing facility.

Likewise, a non-transitory electronically-readable memory medium with electronically-readable control information stored thereon may be present, which includes at least one described computer program (product) and which is embodied in such a way that, when the memory medium is used in a computing facility, it carries out the acts of the server apparatus and/or of the client apparatus of the method in accordance with the third aspect. The non-transitory memory medium may include a data medium or a memory unit.

The server apparatus and the client apparatus may each include a processing unit.

A processing unit may be understood as a data processing device, which contains a processing circuit. The processing unit may process data for carrying out computing operations. These also include where necessary operations for carrying out indexed actions on a data structure, for example, a look-up table (LUT).

The processing unit may contain one or more computers, one or more microcontrollers, and/or one or more integrated circuits, for example, one or more application-specific integrated circuits (ASICs), one or more field-programmable gate arrays (FPGA), and/or one or more systems on a chip (SoC). The processing unit may also contain one or more processors, for example one or more microprocessors, one or more central processing units (CPU), one or more graphics processing units (GPU), and/or one or more signal processors, e.g., one or more digital Signal processors (DSP). The processing unit may also include a physical or a virtual network of computers or other of the units.

In various exemplary embodiments, the processing unit includes one or more hardware and/or software interfaces and/or one or more memory units.

A memory unit may be embodied as a volatile data memory, for example, as a dynamic random access memory (DRAM) or as a static random access memory (SRAM), or as a non-volatile data memory, for example, as read-only memory (ROM), as a programmable read-only memory (PROM), as an erasable programmable read-only memory (EPROM), as an electrically erasable programmable read-only memory (EEPROM), as a flash memory or flash EEPROM, as a ferroelectric random access memory (FRAM), as a magnetoresistive random access memory (MRAM), or as a phase-change random access memory (PCRAM).

Further features of the disclosure emerge from the claims, the figures, and the description of the figures. The features and combinations of features cited above in the description as well as the features and combinations of features cited below in the description of the figures and/or shown in the figures may be included not only in the combination specified in each case, but also in other combinations of the disclosure. In particular, this may include other versions and combinations of features of the disclosure that do not have all the features of an originally formulated claim. Moreover, this may include versions and combinations of features of the disclosure that go beyond the combinations of features set out in the references of the claims or which differ from these.

The disclosure is explained below with the aid of concrete exemplary embodiments and associated schematic diagrams. In the figures, elements that are the same or have the same functions may be provided with the same reference characters. The description of elements that are the same or have the same functions may not necessarily be repeated in relation to different figures.

### BRIEF DESCRIPTION OF THE DRAWINGS

FIG. 1 depicts an example of a schematic depiction of a system that includes a server apparatus and a client apparatus.

FIG. 2 depicts an example of the components of the client apparatus and of the server apparatus.

FIG. 3 depicts an example of a schematic diagram of a first operating mode of the system.

FIG. 4 depicts an example of a schematic diagram of a second operating mode of the system.

FIG. 5 depicts an example of a schematic diagram of a third operating mode of the system.

FIG. 6 depicts an example of a schematic diagram of a method for operating a system for transmission of at least one graphical user interface.

### DETAILED DESCRIPTION

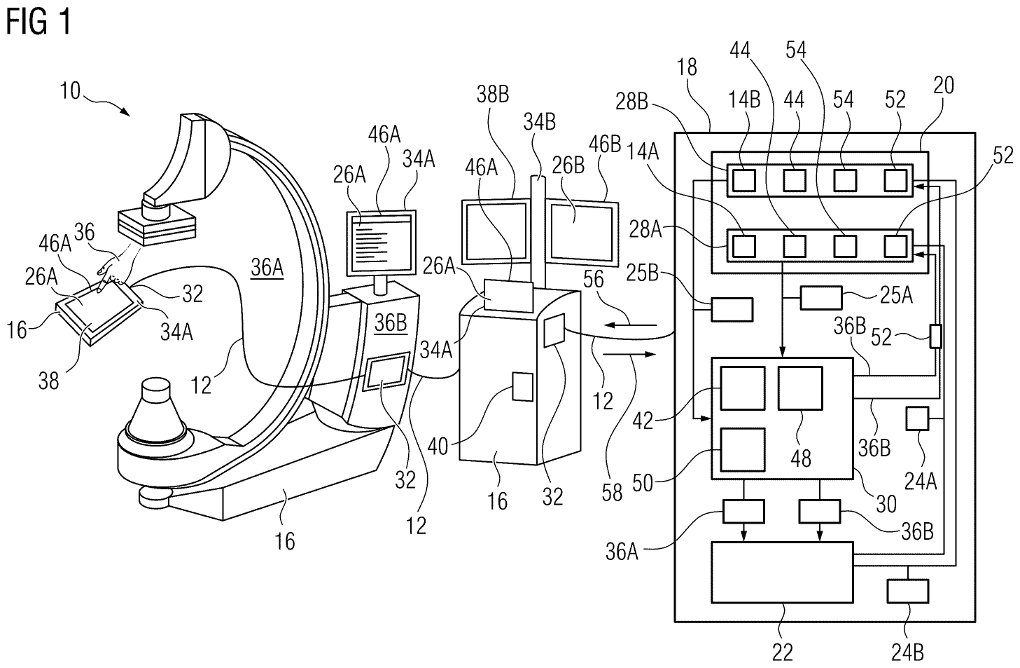

FIG. 1 shows a schematic depiction of a system 10 that includes a server apparatus 18 and a client apparatus 16.

The system 10 for transmission of one or more graphical user interfaces 26A, 26B of a server apparatus 18 to a display facility 46A, 46B of a client apparatus 16 over a packet-based network 12 is shown. The server apparatus 18 includes a display adapter apparatus 20 configured to operate two virtual display entities 28A, 28B, wherein each virtual display facility 14A, 14B is generated by the graphics card of the server apparatus 18.

The server apparatus 18 has an application module 22 configured to provide character data 24 for definition of a graphical user interface 26A, 26B of the application module 22 and of the display adapter apparatus 20 for the virtual display entities 28A, 28B. The display adapter apparatus 20 is configured to transfer the character data 24 to the graphics card of the server apparatus 18 for generation of display data 25A, 25B for the virtual display facility 14A, 14B of the respective virtual display entity 28A, 28B. The display adapter apparatus 20 is configured to transfer the generated display data 25A, 25B to a streaming server facility 30 of the server apparatus 18. The display entity 28A, 28B concerned is the virtual image source for the respective graphical user interface 26A, 26B. The display module 46A, 46B is the respective sink. One of the display entities 28A, 28B may be assigned a number of the display modules 46A, 46B with regard to the respective graphical user interface 26A, 26B.

The streaming server facility 30 is configured to provide an assigned streaming entity 42 for each virtual display entity 28 over a packet-based network 12 to a streaming proxy facility 32 of the client apparatus 16. The streaming proxy facility 32 and the streaming server facility 30 may also encrypt the packet-based communication via the streaming entity 42. The streaming proxy facility 32 and the streaming server facility 30 may be configured to authenticate themselves when setting up the streaming entity 42, in order for example to make access only for permitted partners only.

The streaming server facility 30 is configured to transfer the display data 25A, 25B in a respective display data stream 56A, 56B via the assigned streaming entity 42A, 42B to the streaming proxy facility 32 of the client apparatus 16.

In the version shown, two of the streaming entities 42A, 42B are configured. Alternatively, there may be just one streaming entity 42 or any given number of the streaming entities 42 present. The streaming proxy facility 32 is configured to receive the display data streams 56A, 56B received via two streaming entities 42A, 42B and to extract the display data 25A, 25B from the display data streams 56a, 56B. The streaming proxy facility 32 is configured to forward the display data 25A, 25B to the display modules 34A, 34B of the client apparatus 16 concerned. Display data 25A of a first display data stream 56A, which is assigned to the first streaming entity 42A, may be transferred to three display modules 34A, which may each be assigned to further display facilities 46A of the client apparatus 16. Display data 25B of a second display data stream 56B, which is assigned to the second streaming entity 42B, may be transferred to a display module 34B, which may be assigned to a second display facility 46B of the client apparatus 16. The one display module 46B and the three display modules 46A are only examples of values, e.g., n=>1 per display module applies, without any concrete limit for the number of display locations of a streaming entity 42A, 42B.

The display modules 34A, 34B are configured to send the display data 25A, 25B that the graphical user interfaces 26A, 26B show, to the display facilities 46A, 46B concerned. There may also be provision, during operation, for the graphical user interface 26A, 26B to be shown on one of the display facilities 46A, 46B, to be switched over. In this case, for example, by a request to the streaming proxy facility 32, a type of forwarded display data 25A, 25B may be switched from first display data 25A to second display data 25B, in order to display the second graphical user interface 26B instead of the first graphical user interface 26A on the display facility 46A concerned when this is useful in the workflow. One of the display facilities 46A, 46B may further also display a number of the graphical user interfaces 26A, 26B at the same time, e.g., by picture-in-picture, i.e. the first graphical user interface 26A and the second graphical user interface 26B in parallel in two image areas provided per screen composing. In this case, the streaming proxy facility 32 may send both the first display data 25A, and also the second display data 25B to the display module 34 responsible for the display facility 46.

FIG. 1 shows the case of two different graphical user interfaces 26A, 26B. One of the graphical user interfaces 26B, which is provided via a streaming entity 42B, is shown on one of the display facilities 46B, a further of the graphical user interfaces 26A, which is provided via a further streaming entity 42A, is shown on others of the display facilities 46A. Each of the streaming entities 42A, 42B is allocated a virtual display entity 28A, 28B in the display adapter apparatus 20.

This display adapter apparatus 20 is implemented so that it passes on the character data 24 of the application module 22 to a graphics card present physical in the server apparatus 18 in order to generate the display data 25A, 25B through the card. In other words, it is still possible, in a server apparatus 18 to which no physically present display facility 46 is connected, to pass the graphics card to an application and continue to use all the functions of the graphics card (for example CUDA with nVidia graphics cards). This involves a function that does not offer commercially obtainable solutions for remote transmission of a graphical user interface 26 or only offers them to a restricted extent, in particular in combination with the further features such as latency monitoring over non-deterministic transmission paths such as for example Ethernet-based networks. If one or more physical display facilities 46 are present at the server apparatus 18, the acceleration by the graphics card for the virtual display facilities 46 is likewise retained.

The display adapter apparatus 20 is capable of multiple entities, i.e., a number of secondary display facilities 46A with resolutions and refresh rates differing from the primary display facility 46A, may be dynamically created by the display adapter apparatus 20 in order to provide specific applications 46A to further of the display facilities if need be. Also, further parameters such as individually settable latency threshold values may be determined individually per streaming entity 42.

These secondary display facilities 46A may be used to create a secondary graphical user interface 26A, in order to render contents that differ from the primary graphical user interface 26A for display facilities 46A in the client apparatus 16 provided as a touch display.

As well as the display adapter apparatus 20, there is further a virtual, multitouch-capable input driver 52, which makes possible a simultaneous interaction of the applications operated on the server apparatus 18 by the application module 22 with the input facilities 38 of the client apparatus 16 (e.g., mouse, single, and multitouch screens). This input driver 52 may, if required, mutually lock parallel user inputs 36A, 36B of input facilities 38 with equal authorization. The input driver 52 may also be provided with input facilities 38 for other input modalities such as gesture control. This also enables, with the appropriate input driver 52, such interactions from the client apparatus 16 to be returned via the input data stream 58 of the streaming entity 42 to the application module 22 on the server apparatus 18. The input driver 52 may receive the user inputs 36 of the input facilities 38 and forward the corresponding inputs to the virtual display entity 28. For example, coordinates of a mouse pointer controlled by one of the input facilities 38 may be converted in accordance with the display entity configuration 44 in such a way that they are converted from screen coordinates of the one of the display facilities 46 to screen coordinates of the virtual display facility 14.

The virtual display facilities 28A, 28B are managed on the server apparatus 18 like real display facilities 46A, 46B at operating system level, whereby it is easy for the third-party provider to continue to use their existing technology for provision of the graphical user interface 26 and merely to provide adapted contents on the virtual display facilities 28A, 28B for the client apparatus 16, which will then be streamed by NGS protocol to the client apparatus 16.

The third-party provider may further decide to mirror the graphical user interface 26 for the existing display facility 46 of the server apparatus 18 on the display facility 46 of the client apparatus 16, in that at the operating system level they duplicate or clone their primary display facility 46 on the virtual display facility 14. This means that they have only minimal integration overheads, since their actual application module 22 remains unchanged and the cloning runs at the operating system level uncoupled from the application of the application module 22. The server apparatus 18, in clone mode, may also upscale or downscale the graphical user interface 26 of the virtual display facility 28 and also cut out part areas of the graphical user interface 26, so that the complete contents of the graphical user interface 26 is not streamed. There may be provision for the display data 25 generated for the virtual display facility 28, which depicts the entire graphical user interface 26, to be used as the basis for further display data 25, which may only include a part area of the graphical user interface 26. The further display data 25 may then be provided to a further of the display modules 34.

There is further at least one server entity on the server apparatus 18 (one per virtual display facility 14), which interoperates with the input driver 52 and the display driver 54 and provides an encoding of the screen contents of the virtual display driver.

The described system 10 has the following structure in this case.

The first display module 34B of the client apparatus 16 shows the streamed screen contents of the server apparatus 18 received by Ethernet (cable or also wireless) on a display facility 46B of the client apparatus 16 and accepts user inputs 36B from existing input facilities 38B of the client apparatus 16 and forwards them to the server apparatus 18 or to the respective virtual display entity 28B via network 12. The same applies to the second display module 34A of the client apparatus 16, which may be provided at a separate operator terminal of the client apparatus 16. Both streamed data and also the user inputs 36B run via the streaming proxy facility 32 of the client apparatus 16. The streaming proxy facility 32 may manage multiple display data 25A, 25B from a number of virtual display entities 28A, 28B and interactions of a number of display modules 34A, 34B at the same time.

The control module 40 may run on a separate computer and/or on the client apparatus 16 and/or on the server apparatus 18. The control module 40 notifies the streaming server facility 30 running on the server apparatus 18 by telegram via the streaming proxy facility 32 about the desired resolution and about further streaming parameters for all display modules 34A, 34B. As an alternative, the server apparatus 18 may also request the parameters from the control module 40 when the server apparatus 18 needs another screen resolution or wishes to reduce the input from multitouch to single touch. The application module 22 of the server apparatus 18 may further predetermine individual latency threshold values for the stream. If a maximum latency is exceeded, the application module 22 may be informed accordingly and may set in motion suitable measures (for example, warning, acoustic alarm message, etc.).

The streaming server facility 30 applies a predetermined coding method and informs the input driver 52 and the display driver 54 about the required parameters. These create corresponding virtual display facilities 46 with them. Applications executed on the server apparatus 18 do not have to be configured to this architecture, i.e., the virtual display facilities 46 appear as normal operating system desktops in the extended or duplicated multimonitor setup.

The type of virtual display facilities 46 provides that local resources of the graphics card of the server apparatus 18, despite missing physical display facilities 46, may be used properly, which would not normally be possible without this property, at least under the operating systems 10 that may be used here. The display module 34 becomes part of the user interface of the client apparatus 16 and may represent streams in a different way and scale them if needed, provided the application allows it. Further, quality metrics (e.g., latency exceeding, dropped frames, checksum errors, etc.) are also reported back to the respective application module 22 via the described data connection, which may derive further acts, for example, a warning sound for latency exceeding or a reduction in the image rate. The reaction is defined by the respective provider of the application module 22 within the framework of their product risk assessment. This expansion by specific measures of the application is optional and whether it is to be used may be defined by the third-party provider.

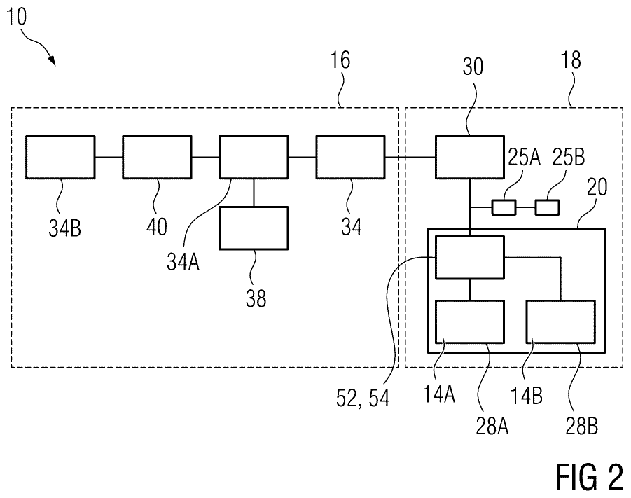

FIG. 2 shows the components of the client apparatus 16 and of the server apparatus 18.

The system 10 includes the server apparatus 18 and the client apparatus 16. The server apparatus 18 and the client apparatus 16 may be connected to one another over a packet-based network 12. The objective of the system 10 may include providing an application on the server apparatus 18, which may be operated in an application module 22. In order to make control of the application operated in the server apparatus 18 possible at the client apparatus 16, or in order to be able to display a function of the application on the client apparatus 16, there may be provision for a graphical user interface 26 of the application to be provided on one more display facilities 46 of the client apparatus 16. In the example shown, the client apparatus 16 has two of the display facilities 46. Respective display modules 34 may be assigned to the display facilities 46. For the first of the display facilities 46, a first graphical user interface 26 of the application may be provided. Also, for the second of the display facilities 46, a second graphical user interface 26 of the application may be provided. The two graphical user interfaces 26 may differ in their contents and in their presentation. The contents may include displayed controls or elements. The presentation may relate to a resolution, a color depth, and a refresh rate.

The application module 22 may be configured to define the content of the graphical user interfaces 26 concerned in respective character data 24. The determination of display data 25, which describes the display of the respective graphical user interface 26, based on the character data 24, is determined by the display adapter apparatus 20. The display data 25 depends on the properties of the display facility 46 and/or the linking in of the graphical user interface 26 in a display on the display facility 46.

According to the prior art, it is necessary, inter alia, to configure the application module 22 in such a way that it already generates the display data 25. Thus, an adaptation of the application module 22 to the respective situation is required, whereby significant extra effort by the third-party provider of the application is necessary. Through the provision of the display adapter apparatus 20, the task of the provision of the display data 25 is transferred from the application module 22 to the display adapter apparatus 20. The application module 22 thus only has to provide the character data 24.

The display adapter apparatus 20 is configured to carry out the character data 24 for generation of the display data 25 by a provision of virtual display entities 28. In the example shown, each display facility 46 of the client apparatus 16 is assigned a respective one of the virtual display entities 28. The virtual display entity 28 concerned provides a virtual display facility 14. The virtual display facility 14 may be assigned corresponding display drivers. The virtual display facility 14 may represent the display facility 46 of the client apparatus 16 or an area of the display facility 46 of the client apparatus 16. The display adapter apparatus 20 is configured to provide the character data 24 to the graphics card of the server apparatus 18. The display entity 28 and the virtual display facility 14 may be configured by a display entity configuration 44. This may be provided by a control module 40. The graphics card, based thereon, may generate the display data 25 for presentation of the respective graphical user interface 26 for the respective virtual display facility 14. The display adapter apparatus 20 may accept the display data 25 and provide it to a streaming server facility 30. An idea is to stream the display data 25 for presentation of the graphical user interface 26 to the client apparatus 16. It is advantageous here that the graphics card of the server apparatus 18 may be integrated.

The streaming server facility 30 is configured to provide a streaming entity 42 assigned to the virtual display facility 14 over a packet-based network 12 to a streaming proxy facility 32 of the client apparatus 16, and to transfer the display data 25 in a display data stream 56 via the assigned streaming entity 42 to the streaming proxy facility 32 of the client apparatus 16. The streaming server facility 30 thus functions as an interface of the server apparatus 18. The interface thus does not have to be provided by the application module.

The streaming proxy facility 32 may be configured for the NGS protocol. The streaming proxy facility 32 may be configured to encode the imaging data and transfer it in the imaging data stream. The streaming proxy facility 32 is the corresponding counterpart and thus functions as an interface of the client apparatus 16 for the packet-based network 12. The streaming proxy facility 32 may be configured to receive the imaging data stream and to decode it accordingly for provision of the imaging data. The streaming entity 42 may be configured by a streaming configuration 48, which may be provided to the streaming server facility 30 by the control module 40. The streaming configuration 48 may predetermine latency threshold values 50 for the display data stream 56 and/or the input data stream, from which a predetermined measure will be initiated by the streaming proxy facility 32 and/or the streaming server facility 30. The streaming configuration 48 may also define a level of compression and a bandwidth to be provided for the streaming entity 42.

The streaming proxy facility 32 is configured to forward the imaging data to the display module 34 concerned. The display modules 34 are configured to convey the display data 25 to the assigned display facility 46, in order for the graphical user interface 26 to be displayed by the display facility 46. For interaction, an input facility 38 may be provided, which may be connected to one of the display modules 34. The display module 34 may accept user inputs 36 of the input facility 38 and provide them to the streaming proxy facility 32. The streaming proxy facility 32 may forward the user inputs 36 via an input data stream 58 in the streaming entity 42 to the streaming server facility 30. The streaming server facility 30 may provide the user inputs 36 to the virtual display entity 28 concerned. By the input driver 52 the user inputs 36 may be processed and the application operated in the application module activated.

The system 10 may be intended for the NGS protocol. The NGS (Network GUI Sharing) protocol is a system 10 for remote control of the graphical user interfaces 26 of server apparatuses 18 that are connected to client apparatuses 16. It makes it possible for a client apparatus 16 to display and to control a graphical user interface 26 of the server apparatus 18. Since it works at frame buffer level, from the architectural perspective, NGS supports all window systems 10 and applications from third-party provider systems 10.

A number of entities may be executed on the same server apparatus 18 at the same time, in order to stream a number of graphical user interfaces 26 at the same time to separate ports. It is also possible to execute other server entities that are located at other IP addresses and are connected at the same time to the same streaming proxy facility 32.

The streaming proxy facility 32 may be executed on the client apparatus 16 and may connect to one or more of the server apparatuses 18 at the same time. The streaming proxy facility 32 forwards the display data 25 to the display modules 34 of the client apparatus 16, which is assigned to the display facility 46 for display of the graphical user interface 26.

The NGS protocol uses various mechanisms for monitoring and guaranteeing the timely provision of the display data 25, which describes the graphical user interface 26. These include absolute frame latency (AFL), network bandwidth, heartbeat timeout, RTT and surveillance of continuous update. These mechanisms may be used in order to provide that the graphical user interface 26 on the client apparatus 16 is updated in good time and the delays or outages detected and that appropriate measures may be initiated.

For each streaming entity 42, a version handshake is required in order to provide that only compatible NGS versions are coupled in. For each of the streaming server facilities 30 to which the streaming proxy facility 32 is connected, a replicated port is provided in the internal network 12 of the client apparatus 16 to which the display modules 34 may connect in order to obtain the same (replicated) display data 25 for display of the graphical user interface 26. The streaming proxy facility 32 may also take over the arbitrage of the interactions of the connected display modules 34, in order to provide that the interaction at one display module 34 does not block interactions on all other display modules 34 located beyond the streaming proxy facility 32. A handover of interactions between display modules 34 is not permitted.

An important function of the streaming proxy facility 32 is also the gatekeeper role in order to provide that no damaging data traffic from the external network 12 may penetrate into the internal system network 12 of the client apparatus 16. The streaming proxy facility 32 also supports the handshake method (for authentication and encryption) to the streaming server facility 30 and deal with different refresh rates for the display modules 34. The streaming proxy facility 32 supports an algorithm for reducing the refresh rate for slower display modules 34 that do not support the incoming refresh rate, in order to avoid function-critical components.

The display modules 34 may connect to the streaming proxy facility 32 via the internal TCP/IP-network 12 of the client apparatus 16. It is also possible for a display module 34 to run on the same physical/virtual system 10 as the streaming proxy facility 32. The display modules 34 may display the streamed graphical user interface 26 and collect user inputs 36 (touch commands and mouse inputs) in order to transfer them to the streaming proxy facility 32, which forwards the user inputs 36 to the streaming server facility 30 where they may be processed. As well as mouse/touch inputs (single or multiple) keyboard commands or audio/haptic feedback (where applicable) may be transmitted. The streaming server facility 30 is responsible for the streamed graphical user interface 26. The display modules 34 may have scaled the graphical user interface 26 to the available space of an allocated video frame area and also map the mouse/touch coordinates accordingly. In order to avoid distortions and to provide an optimal image quality, the server apparatus 18 supports the supported screen resolutions, for example 1280×720 for a pixel-precise 1:1 display.

All three communication nodes (i.e., server apparatus 18, streaming proxy facility 32, and display modules 34) may also contain an implementation of the real time clock (RTC) discrepancy calculation, in order to measure the overall transmission delay of the graphical user interface 26 and be able to notify the server. The server may then decide, because of the individual classification of the streamed graphical user interface, which reaction is suitable for a specific transmission delay. What is more, the display modules 34 may have a mechanism available for detecting delays above a configurable threshold and informing the user that the “out-of-date” graphical user interface contents are present with the exceeding of the latency. This information may be shown by a red, half-transparent overlay, which shows that the latency limit has been exceeded. In cases of such exceeding of the limit, the mouse/touch inputs from the display modules 34 are blocked and ongoing interactions aborted in order to avoid outdated (“too old”) graphical user interface remote control being carried out at the Cios system. What is more, the physical link speed during the connection time is monitored in order to avoid streaming via slow network connections, which may be caused by bad cables and the MAC/NIC auto negotiation process or temporarily adversely effected Wi-Fi performance.

The communication nodes are capable of processing the NGS protocol completely encapsulated and are also responsible for error handling, recovery from errors (e.g., automatic reconnection after connection loss) and for the display of relevant information for the user, for example, when the network cable is pulled out or when the network speed lies below an acceptable threshold for secure communication.

The display modules 34 are divided into the standard Cios/CIARTIC touch UIs and a new communication node, the so-called MCP (Monitor Control Panel). On request, the MCP overlays the GUI contents of the display facility 46. All display modules 34 communicate via the AXCS interface with the system controller and may be controlled by the TUI-IF. The NGS is configured so that it does not cause any critical delays for the (A)XCS-traffic on the internal system network that runs in parallel with it. Since this network 12, for reasons of cost, does not support any protocol apart from QoS (for example like ProfiNet offers) or switches apart from QoS (for example, offered by a managed switch), the streaming proxy facility 32 also implements a load regulation mechanism in order to provide that the other system traffic is not adversely affected by the video input. In all display modules 34 a rectangular display area may be present, in which the streamed graphical user interface 26 is displayed and with which the user may interact. This area also contains local user messages. On the Touch UIs, this display field may also contain relevant radiation values (for example, kV, mA, dose, accumulated irradiation time), in order to make possible the normal operation of the Cios system 10 (in particular of the radiation release) in parallel to the also visible GUI of third-party providers. A “hybrid” mode of operation is also possible. As depicted in the screenshot as a suggestion for the design of this hybrid screen, the upper banner contains the Cios contents and the lower part is reserved for the third-party provider content.

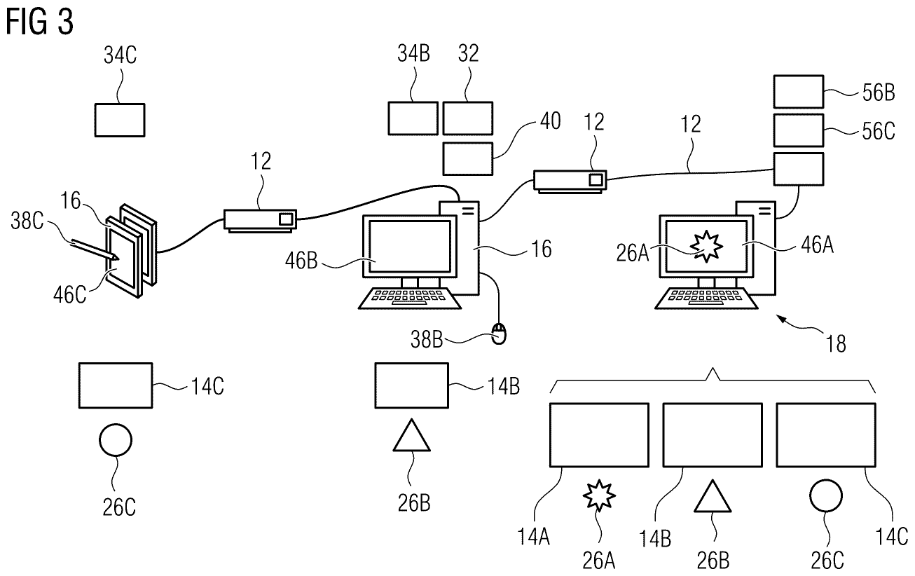

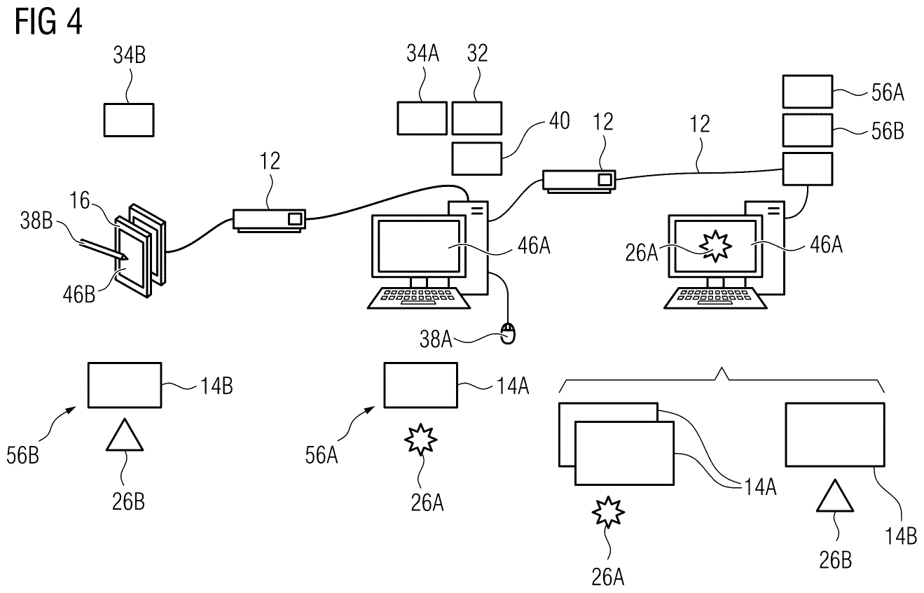

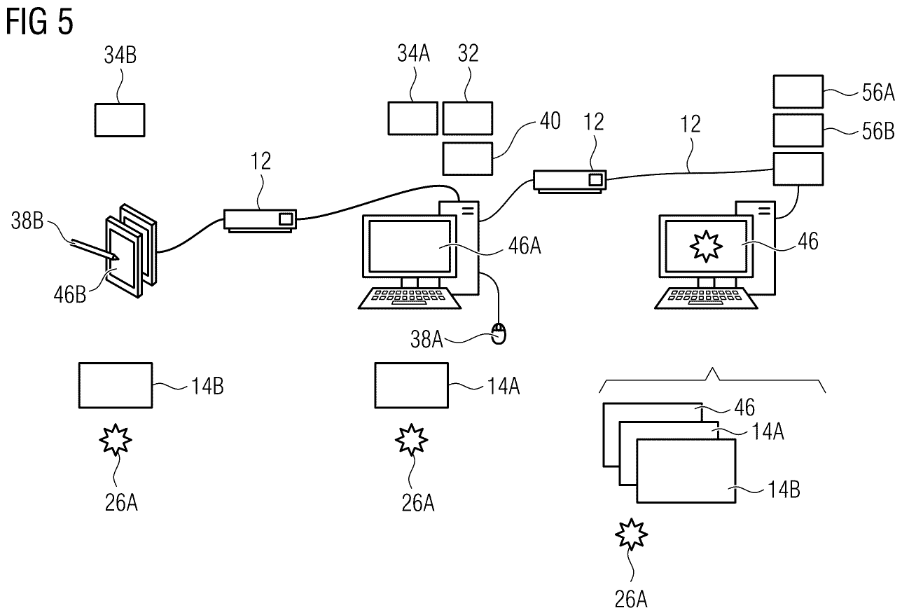

FIG. 3, FIG. 4, and FIG. 5 show various modes of operation of the system 10.

The following examples show the operation of the display adapter apparatus 20 in three variants.

FIG. 3 shows a schematic diagram of a first operating mode of the system.

In FIG. 3, the display facility 46 of the server apparatus 18 shows a first graphical user interface 26A. The server apparatus 18 creates a second graphical user interface 26B for display of a second display facility 46B of the client apparatus 16, and also a third graphical user interface 26C for display on a third display facility 46 of the client apparatus 16. The display data 25B, 25C for display of the second graphical user interface 26B and the third graphical user interface 26C is transferred to the display modules 34B, 34C concerned.

The graphical user interfaces 26A, 26B, 26C may differ from one another. The first virtual display facility 14B and the second virtual display facility 14C are operated in this case in Extended Desktop Mode.

FIG. 4 shows a schematic diagram of a second operating mode of the system.

FIG. 4 shows, for the display facility 46 of the server apparatus 18, the first graphical user interface 26A in accordance with first character data. The first graphical user interface 26A may be described in first display data 25A. The second graphical user interface 26B may likewise be created in accordance with the first character data 24A and shown on the first virtual display facility 14A. The second graphical user interface 26B may be described in second display data 25B.

This may be undertaken in a clone mode, in which the graphical user interface 26A in accordance with the first character data is displayed on the display facility 46A of the server apparatus 18 and of the virtual display facility 14A. An optionally needed scaling may be handled by the streaming server facility 30 and/or the first display module 34A if the resolution of the display facility 46A of the server apparatus 18 and the virtual display facility 14A are not identical. This enables display data 25A, 25B that differs from each other to be created for the two display facilities 46A, 46B.

A third second user interface 26B described by the second display data 25B, which may be created based on second character data 24B, may be shown on the second display facility 46B, which is assigned to the second display module 34B. The virtual display facilities 14A, 14B are operated in this case in mixed mode clone +extended desktop mode.

FIG. 5 shows a schematic diagram of a third operating mode of the system.

In FIG. 5, the display facility 46 of the server apparatus 18 shows a content. The identical content may be displayed on the first virtual display facility 14A and the second virtual display facility 14B. An optionally needed scaling is accepted from the streaming server facility 30 or the display modules 34A, 34B, if the resolution of the display facility 46 of the server apparatus 18 and of the virtual display facilities 14A, 14B are not identical. The virtual display facilities 14A, 14B are operated in this case in clone desktop mode.

The already known NGS method with its properties for secure, latency-monitored transmission of security-critical GUI contents is expanded by the described functions, which in this combination produce an innovative transmission system.

It is proposed that a display adapter apparatus 20, a streaming server facility 30, input drivers 52, and display drivers 54 be installed on the external server apparatus 18 of the third-party provider for each of the graphical user interfaces 26, where the provider wants to provide individually for display on a display facility 46A, 46B of the client apparatus 16.

The advantage compared to the provision of source code for connection of the third-party provider to the streaming network 12 is that the virtual display facility 14A, input driver 52 and display driver 54 and also the streaming server facility 30 are available as binary data and in the simplest case need no integration into the application module 22. This makes the actual streaming interface much easier to maintain and develop, since close intermeshing with the application module 22 and its source code is no longer needed. Moreover, no internals of the streaming interface are revealed. Moreover, through the decoupling by the virtual display and input driver 52 and display driver 54, the software functions with each application of the third-party provider, regardless of which display technology (for example, HTML5, Qt, WPF, etc.) it uses. In this way, the onboarding of new application modules 22 is massively simplified and accelerated.

If, for example, the provider may provide two streaming entities 42, one for a display of the graphical user interface 26A on a display facility 46A present as the main monitor and one for a display of the graphical user interface 26B on a display facility 46B present as a TouchUI operator console for a client apparatus 16 embodied as a mobile C-arm. In this example, the provider may install two of the virtual display facilities 14A, 14B in respective virtual display entities 28A, 28B of the display adapter apparatus 20 in accordance with respective display entity configurations 44A, 44B.

If the third-party provider wishes to provide identical display data 25 for display of the graphical user interface 26 to all display facilities 46A, 46B, a virtual display entity 28A, the streaming server facility 30, the input driver 52, and the display driver 54 are sufficient.

To this end, the proposed system 10 is capable of displaying medical interactive graphical user interfaces 26A, 26B of server apparatuses 18 over a packet-based network 12 on client apparatuses 16 and making them operable. By comparison with conventional systems 10, this system 10 offers additional function blocks, which expand the functional scope. A monitored and programmable latency, a multi-display operation, virtual display entities 28 for a simple integration of the server apparatuses 18, an internal routing of display data streams on a number of display facilities 46A, 46B and also the arbitration of parallel user inputs 36A, 36B belong to these functional blocks.

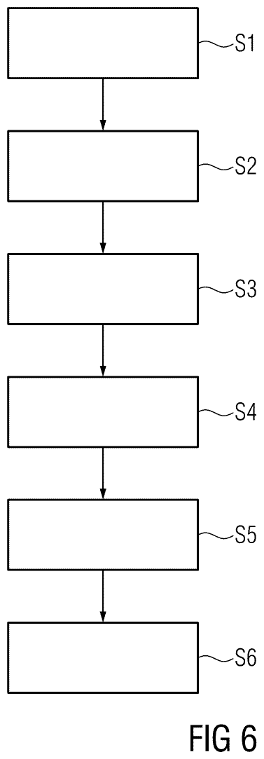

FIG. 6 shows a schematic diagram of a method for operating a system 10 for transmission of at least one graphical user interface 26.

### The Method may Include the Following Acts.

A first act S1 may include the provision of a virtual display entity 28 corresponding to a display entity configuration 44 by a display adapter apparatus 20 of the server apparatus 18. A virtual display unit may be provided in the virtual display entity 28.

A second act S2 may include the provision of character data 24 for definition of the graphical user interface 26 of an application of the application module to a display adapter apparatus 20 for a virtual display entity 28.

A third act S3 may include the provision of character data 24 for generation of display data 25 for display of the graphical user interface 26 to a graphics card of the server apparatus 18 and transfer of the generated display data 25 to a streaming server facility 30 of the server apparatus 18.

A fourth act S4 may include the provision of a streaming entity 42 assigned to the virtual display unit over a packet-based network 12 to a streaming proxy facility 32 of the client apparatus 16 by the streaming server facility 30, as well as the transfer of the display data 25 in a display data stream 56 via the assigned streaming entity 42 to the streaming proxy facility 32 of the client apparatus 16 by the streaming server facility 30.

A fifth act S5 may include the receipt of the display data stream 56 transferred via the assigned streaming entity 42 by the streaming proxy facility 32 and forwarding of the display data 25 to a display module 34 of the client apparatus 16, which is assigned to the display unit.

A sixth act S6 may include the sending of the display data 25 to the display unit by the display module 34.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

1. A server apparatus for provision of at least one graphical user interface to a client apparatus over a packet-based network, the server apparatus comprising:
an application module configured to generate character data for definition of the graphical user interface of an application of the application module and to provide the character data to a display adapter apparatus;
the display adapter apparatus configured to:
operate a virtual display entity, in accordance with a display entity configuration, in which a virtual display facility is provided;
provide the character data for generation of display data for display of the graphical user interface in the virtual display facility of the virtual display entity to a graphics card of the server apparatus; and
transfer the generated display data to a streaming server facility of the server apparatus; and
the streaming server facility configured to:
provide a streaming entity assigned to the virtual display facility over the packet-based network to a streaming proxy facility of the client apparatus; and
transfer the display data in a display data stream via the assigned streaming entity to the streaming proxy facility of the client apparatus.

2. The server apparatus of claim 1, wherein the streaming server facility is further configured, in the streaming entity, to receive user inputs from the streaming proxy facility of the client apparatus and provide the user inputs to the display adapter apparatus for the virtual display entity, which is allocated to the streaming entity; and
wherein the display adapter apparatus is further configured to forward the user inputs to the application module of a display entity.

3. The server apparatus of claim 1, wherein a streaming configuration predetermines latency threshold values for the streaming entity, and
wherein the streaming server facility is further configured to initiate a predetermined measure using the latency threshold values.

4. The server apparatus of claim 1, wherein the streaming server facility is further configured to configure a display driver of the virtual display facility of the virtual display entity.

5. The server apparatus of claim 1, wherein the display adapter apparatus is further configured, in a multi entity mode, to operate a number of virtual display entities in accordance with respective display entity configurations,
wherein the display adapter apparatus is further configured to provide respective display data for display of a respective graphical user interface in a respective virtual display facility of a respective virtual display entity to the graphics card of the server apparatus, and transfer the display data of the respective virtual display entity to the streaming server facility of the server apparatus, and
wherein the streaming server facility is further configured, in the streaming entity assigned to the respective virtual display facility, to transfer the respective display data in the display data stream over the packet-based network to the streaming proxy facility of the respective client apparatus.

6. The server apparatus of claim 5, wherein the display adapter apparatus is further configured to receive the character data of the application module for definition of the graphical user interface and provide a number of the virtual display entities of the display adapter apparatus.

7. The server apparatus of claim 5, wherein the display adapter apparatus is further configured to receive a number of the character data of respective application modules for definition of the respective graphical user interface and provide the character data to the respective virtual display entity of the virtual display entities of the display adapter apparatuses.

8. The server apparatus of claim 5, further comprising:
a scaling facility configured to:
receive the display data of a virtual display entity of the virtual display entities for display of the graphical user interface in accordance with the display entity configuration;
generate scaled display data for displaying at least one part of the graphical user interface in accordance with a scaling configuration based on the received display data; and
provide the scaled display data to the streaming server facility.

9. The server apparatus of claim 1, wherein the streaming server facility is further configured to receive the display data of the virtual display entity and transfer, in a number of streaming entities assigned to the virtual display facility, the display data in the respective display data stream over the packet-based network to the streaming proxy facility of the respective client apparatus.

10. A client apparatus for receiving at least one graphical user interface from a server apparatus over a packet-based network, the client apparatus comprising:
a streaming proxy facility configured to receive display data for display of the graphical user interface in a display data stream via a streaming entity and forward the display data to a display module assigned to a display facility; and
the display module configured to send the display data to the display facility in order to display the graphical user interface on the display facility.

11. The client apparatus of claim 10, further comprising:
a control module configured to provide a streaming server facility via the streaming entity with a display entity configuration.

12. The client apparatus of claim 11, wherein the control module is further configured to provide a streaming configuration of the streaming entity to the streaming server facility via the streaming entity.

13. A system comprising:
a server apparatus; and
a client apparatus,
wherein the server apparatus comprises:
an application module configured to generate character data for definition of a graphical user interface of an application of the application module and to provide the character data to a display adapter apparatus;
the display adapter apparatus configured to: operate a virtual display entity, in accordance with a display entity configuration, in which a virtual display facility is provided; provide the character data for generation of display data for display of the graphical user interface in the virtual display facility of the virtual display entity to a graphics card of the server apparatus; and transfer the generated display data to a streaming server facility of the server apparatus; and
the streaming server facility configured to: provide a streaming entity assigned to the virtual display facility over a packet-based network to a streaming proxy facility of the client apparatus; and transfer the display data in a display data stream via the assigned streaming entity to the streaming proxy facility of the client apparatus; and
wherein the client apparatus comprises:
the streaming proxy facility configured to receive the display data for display of the graphical user interface in the display data stream via the streaming entity and forward the display data to a display module assigned to a display facility; and
the display module configured to send the display data to the display facility in order to display the graphical user interface on the display facility.

14. A method for operating a system for transmission of at least one graphical user interface of a server apparatus to a display facility of a client apparatus over a packet-based network, the method comprising:
providing a virtual display entity in accordance with a display entity configuration by a display adapter apparatus of the server apparatus, in which a virtual display facility is provided;
providing character data for definition of the graphical user interface of an application of an application module to the display adapter apparatus for the virtual display entity;
generating, using the character data, display data for display of the graphical user interface to a graphics card of the server apparatus;
transferring the display data to a streaming server facility of the server apparatus;
providing a streaming entity assigned to the virtual display facility over the packet-based network to a streaming proxy facility of the client apparatus by the streaming server facility;
transferring the display data in a display data stream via the assigned streaming entity to the streaming proxy facility of the client apparatus by the streaming server facility;
receiving the display data stream transferred via the assigned streaming entity by the streaming proxy facility;
forwarding the display data to a display module of the client apparatus, which is assigned to the display facility; and
transmitting the display data to the display facility by the display module.
